(19) United States
(12) Patent Application Publication
(10) Pub. No.: US 2026/0332631 A1
(43) Pub. Date: Oct. 22, 2026

(54) METHOD AND DEVICE FOR DEFINING PRE- AND POST-STATE FEATURES FOR ATTACK TECHNIQUE IN THREAT MODEL

(71) Applicant: ELECTRONICS AND TELECOMMUNICATIONS RESEARCH INSTITUTE, Daejeon (KR)

(72) Inventors: Ki Jong KOO, Daejeon (KR); Dae Sung Moon, Daejeon (KR); Jae Hak Yu, Daejeon (KR); Yang Seo Choi, Daejeon (KR)

(21) Appl. No.: 19/529,423

(22) Filed: Feb. 4, 2026

(30) Foreign Application Priority Data
Feb. 6, 2025 (KR) 10-2025-0015238

(51) Int. Cl. H04L 9/40

(52) U.S. Cl. CPC H04L 63/1433

(57) ABSTRACT

The present invention relates to a method and an apparatus for defining pre-state and post-state features for attack techniques of a threat model. According to one aspect of the present invention, a method for generating a cyber attack sequence may include: generating a cyber attack simulation environment based on a simulated training scenario; loading a pre-trained cyber attack agent model; and generating the cyber attack sequence based on attack techniques defined by the pre-trained cyber attack agent model for the cyber attack simulation environment. Here, the attack techniques may include features for a pre-state and a post-state for at least one host.

### CROSS-REFERENCE TO RELATED APPLICATION

This application claims the benefit of earlier filing date and right of priority to Korean Application No. 10-2025-0015238, filed on Feb. 6, 2025, the contents of which are all hereby incorporated by reference herein in their entirety.

### TECHNICAL FIELD

The present disclosure relates to a method and an apparatus for defining pre-state and post-state features of attack techniques of a threat model for rapidly training a reinforcement learning-based cyber attack agent (model) in various penetration testing environments and for generating a cyber attack scenario (e.g., a cyber attack sequence) having high accuracy applicable to a real-world environment.

### BACKGROUND

As cyber attacks by hackers armed with AI technologies become increasingly sophisticated and large-scale, the paradigm of cyber warfare is shifting from a traditional post-incident response approach of detecting cyber attacks and establishing response systems (e.g., perimeter network security, EDR, etc.) to a proactive prevention approach of supplementing security vulnerabilities through evaluation of the security level of a target organization (e.g., penetration testing, etc.).

In addition, the proactive prevention approach of supplementing security vulnerabilities through evaluation of the security level of a target organization is currently largely dependent on the professional capabilities of white-hat hackers, and reveals limitations in domain-wide penetration testing and continuous security inspection.

Meanwhile, due to an all-encompassing increasing trend of cyber threats, a shortage of information security personnel is expected in the future, and there is a demand for cultivating cyber security professionals through customized convergent and composite education for organizations of national

Cyber response systems, the military, and domestic enterprises.

In addition, cyber warfare training tools are being developed worldwide under government leadership, and are utilized to train and cultivate cyber security experts. For example, overseas examples include NCR (U.S. DARPA), CyberGym (Israel), and CyRIS (Japan JAIST), and domestic examples include the Cyber Security Training Center of the National Security Research Institute (NSR), the Security-Gym of the Korea Internet & Security Agency (KISA), training grounds for cyber defense competitions, the cyber defense training ground of the Cyber Operations Command, and cyber training grounds of the Army, Navy, and Air Force.

In order to maximize the training effectiveness of major cyber training ranges, securing a variety of attack-and-defense scenarios is most important. Existing attack-and-defense scenarios of cyber training ranges are generated by creating arbitrary attack-and-defense scenarios based on the knowledge of experts (e.g., white-hat hackers), or by securing attack scenarios based on intrusion incidents or cases and then performing simulated attacks (e.g., emulation). For this reason, there may be constraints in modeling complex configurations of real environments (e.g., networks, security systems, virtual network emulators, etc.), and as a result, there may be limitations in generating various attack-and-defense scenarios, such that it tends to be limited to the cultivation of personnel at a basic training level, and there is a problem in that training for responding to the latest attacks may be difficult.

In order to address these problems, there is a need for a customized cyber training range reflecting training objectives, trainee levels, and domain requirements, and there is a need to generate a variety of attack-and-defense scenarios that enable diverse attack/defense attempts across an overall actual complex network cyber system.

### SUMMARY

A technical objective of the present disclosure is to provide a method and an apparatus for defining pre-state and post-state of attack techniques based on a threat model (e.g., the MITRE ATT&CK framework) in order to rapidly train a reinforcement learning-based cyber attack agent (model) in various penetration testing environments and to generate a cyber attack scenario (e.g., a cyber attack sequence) having high accuracy applicable to a real-world environment.

The technical objects to be achieved by the present disclosure are not limited to the above-described technical objects, and other technical objects which are not described herein will be clearly understood by those skilled in the pertinent art from the following description.

A method for generating a cyber attack sequence according to an aspect of the present disclosure may comprise: generating a cyber attack simulation environment based on a simulated training scenario; loading a pre-trained cyber attack agent model; and generating the cyber attack sequence based on attack techniques defined by the pre-trained cyber attack agent model for the cyber attack simulation environment. Herein, the attack techniques may include features for a pre-state and a post-state for at least one host.

An apparatus for generating a cyber attack sequence according to an additional aspect of the present disclosure may comprise one or more processors and one or more memories, wherein the one or more processors are configured to: generate a cyber attack simulation environment based on a simulated training scenario; load a pre-trained cyber attack agent model; and generate the cyber attack sequence based on attack techniques defined by the pre-trained cyber attack agent model for the cyber attack simulation environment. Herein, the attack techniques may include features for a pre-state and a post-state for at least one host.

As one or more non-transitory computer-readable media storing one or more instructions according to an additional aspect of the present disclosure, wherein the one or more instructions are executed by one or more processors such that an apparatus for generating a voxel-wise texture patch may control to: generate a cyber attack simulation environment based on a simulated training scenario; load a pre-trained cyber attack agent model; and generate the cyber attack sequence based on attack techniques defined by the pre-trained cyber attack agent model for the cyber attack simulation environment. Herein, the attack techniques may include features for a pre-state and a post-state for at least one host.

In various aspects of the present disclosure, based on the attack technique corresponding to a remote attack technique, the at least one host may include a source host and a destination host, and based on the attack technique corresponding to a local attack technique, the at least one host may include a destination host.

In various aspects of the present disclosure, the features for the pre-state and the post-state may include at least one of a host status feature, a host privilege feature, or a host asset feature, and the host asset feature may include one or more of an operating system-related feature, a service-related feature, an application-related feature, or a file-related feature.

In various aspects of the present disclosure, each of the operating system-related feature, the service-related feature, and the application-related feature may be classified into one or more of a type feature, a status feature, or a vulnerability feature.

In various aspects of the present disclosure, the file-related features may be classified into one or more of a type feature, a status feature, an access permission feature, or an identifier feature.

In various aspects of the present disclosure, the pre-trained cyber attack agent model may be stored based on i) iterative learning for determining an optimal action based on input environment state information and ii) comparative verification with a manual-based attack sequence.

In various aspects of the present disclosure, the attack techniques may be defined based on analysis of attack techniques provided in the simulated training scenario and updates of host states.

In various aspects of the present disclosure, the cyber attack simulation environment may include a network model, an action space, a state space, and a reward function, the action space may include information for pairs of target hosts included in the network model and attack techniques, and the state space may include information for states of all hosts included in the network model and execution results of attack techniques.

In various aspects of the present disclosure, the attack techniques may be based on attack sub-techniques of a threat model.

According to an embodiment of the present invention, by utilizing AI (artificial intelligence)-based cyber attack-and-defense simulation technology, vulnerability analysis and evaluation of cyber response strategies for national critical infrastructures (e.g., energy, transportation, manufacturing, etc.) may be performed, thereby being applicable to securing cyber safety of national critical infrastructures, which provides a technical effect of preventing large-scale economic and social damages that may occur upon occurrence of a cyber attack.

In addition, according to an embodiment of the present invention, the AI-based cyber attack-and-defense simulation technology has a technical effect of being usable as a cyber attack/defense training platform for cultivating cyber security personnel in order to enhance cyber warfare response capabilities. In this regard, by generating/providing training-purpose-customized cyber attack-and-defense scenarios using artificial intelligence technology, there is an advantage that highly trained cyber security personnel may be cultivated.

In addition, according to an embodiment of the present invention, there is an advantage in that AI-based cyber attack and defense scenarios may be utilized as a security consulting tool for ICT infrastructures of private and public institutions and as a function/performance evaluation/verification tool for security solutions installed in a target domain.

Effects achievable by the present disclosure are not limited to the above-described effects, and other effects which are not described herein may be clearly understood by those skilled in the pertinent art from the following description.

### BRIEF DESCRIPTION OF THE DRAWINGS

The accompanying drawings, which are incorporated in and are incorporated in and are intended to aid in the understanding of the present disclosure, provide embodiments of the present disclosure and, together with the detailed description, serve to explain the technical features of the present disclosure.

FIG. 1 illustrates a conceptual diagram of a reinforcement learning-based cyber attack simulation according to an embodiment of the present disclosure.

FIG. 2 illustrates a simulated training scenario configuration file according to an embodiment of the present disclosure.

FIG. 3 illustrates a network model according to an embodiment of the present disclosure.

FIG. 4 illustrates attack techniques according to an embodiment of the present disclosure.

FIG. 5 illustrates an action space composed of host-specific spatial techniques according to an embodiment of the present disclosure.

FIG. 6 illustrates types of pre-state and post-state (PPS) features according to an embodiment of the present disclosure.

FIG. 7 illustrates classification of type, state, and vulnerability features for pre-state and post-state (PPS) according to an embodiment of the present disclosure.

FIG. 8 illustrates classification of file features for pre-state and post-state (PPS) according to an embodiment of the present disclosure.

FIG. 9 illustrates pre-state and post-state (PPS) defined for attack techniques according to an embodiment of the present disclosure.

FIG. 10 illustrates a reinforcement learning environment state table configuration using pre-state and post-state of attack techniques according to an embodiment of the present disclosure.

FIG. 11 illustrates a reinforcement learning-based cyber attack agent training model according to an embodiment of the present disclosure.

FIG. 12 illustrates an attack sequence provided in a simulated training scenario according to an embodiment of the present disclosure.

FIG. 13 illustrates a manual-based attack sequence according to an embodiment of the present disclosure.

FIG. 14 illustrates a DQN network structure and training hyper-parameters according to an embodiment of the present disclosure.

FIG. 15 illustrates training results of a cyber attack agent according to an embodiment of the present disclosure.

FIG. 16 illustrates an attack scenario generated by a DQL agent at a timing of training completion according to an embodiment of the present disclosure.

FIG. 17 illustrates a simulated training scenario configuration and an attack execution procedure according to an embodiment of the present disclosure.

FIG. 18 illustrates an attack sequence composed of attack techniques based on a modified threat model according to an embodiment of the present disclosure.

FIG. 19 illustrates an operational flowchart of a cyber attack sequence generation method according to an embodiment of the present disclosure.

FIG. 20 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

As described above, as cyber warfare becomes more sophisticated, it is necessary to secure a variety of attack-and-defense scenarios in order to maximize the training effectiveness of cyber training ranges. In other words, there is a need for a customized cyber training range reflecting training objectives, trainee levels, and domain requirements, and there is a need to generate a variety of attack-and-defense scenarios that enable diverse attack/defense attempts across an overall actual complex network cyber system.

To this end, various research groups worldwide are conducting research on reinforcement learning-based autonomous penetration testing agents. For example, penetration testing is defined as a Markov Decision Process (MDP) problem, and by training an agent to perform optimal attacks for a given network environment, a cyber attack scenario (a sequence or Course of Actions (CoAs)) may be generated through a reinforcement learning-based cyber attack agent. Such reinforcement learning-based cyber attack scenario generation technologies are being studied as being divided into emulation-based technologies and simulation-based technologies.

Emulation technology virtualizes network and host environments using virtualization technology and generates attack scenarios by applying attack techniques used by actual human hackers. However, while emulation technology provides high attack accuracy, it has limitations in that a significant amount of time is required to collect data necessary for training a reinforcement learning agent. In addition, most major simulation-based technologies that are actively being researched simplify the states of environments (e.g., networks and hosts) and abstract actions (e.g., attack techniques) during development. However, under such conditions, attack scenarios generated by a cyber attack agent trained thereby have low simulation accuracy, and thus have limitations in being applied to a real-world environment (e.g., a network).

In order to overcome the above-described limitations of cyber attack simulation technologies, the present disclosure proposes a method and an apparatus for defining pre-state and post-state features of attack techniques based on a threat model (e.g., the MITRE ATT&CK framework) in order to rapidly train a reinforcement learning-based cyber attack agent (model) in various penetration testing environments and to generate a cyber attack scenario (e.g., a cyber attack sequence) having high accuracy applicable to a real-world environment.

In this regard, in order to overcome limitations in application to a real-world environment due to low accuracy (fidelity) of existing cyber attack simulation technologies, the present disclosure proposes a method for generating a network cyber attack simulation environment based on various simulated training scenarios and for configuring a reinforcement learning action space using attack techniques based on a threat model (e.g., the MITRE ATT&CK framework).

In addition, the present disclosure proposes a method for defining pre-state and post-state features for attack techniques for representing host states before and after a cyber attack, and for configuring a reinforcement learning environment state space based on generated/defined features.

In addition, the present disclosure proposes a method for training a cyber attack agent (rapidly) by utilizing cyber attack simulation (e.g., analysis and execution of attack techniques of a network model, and host state updates).

For clarity of description, in the proposed method of the present disclosure, a threat model is described using the MITRE ATT&CK framework as a representative example, but the proposed method of the present disclosure may be extended and applied to other types of threat models.

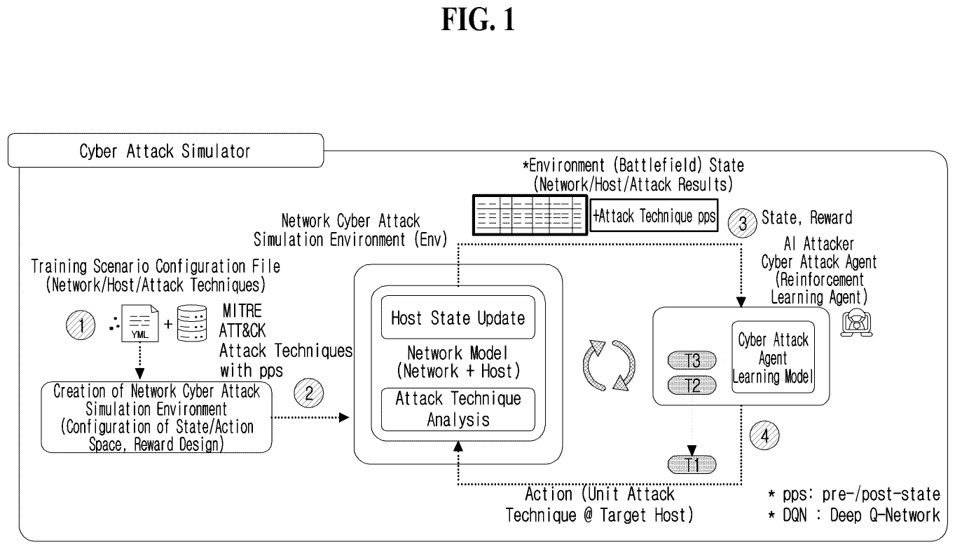

FIG. 1 illustrates a conceptual diagram of a reinforcement learning-based cyber attack simulation according to an embodiment of the present disclosure.

Referring to FIG. 1, a reinforcement learning-based cyber attack sequence generation method related to the proposed method of the present disclosure may include: 1) a cyber attack simulation environment generation step, 2) a cyber attack agent modeling (for example, generation/training) step, and 3) a cyber attack sequence generation step.

For example, the cyber attack simulation environment generation step may include a step of loading a simulated training scenario configuration file and a step of generating a network cyber attack simulation environment. Here, the step of generating the network cyber attack simulation environment may include a step of generating a network model and a step of configuring a state space, an action space, and a reward function for modeling the simulation environment as an MDP (Markov Decision Process). As an example, the method of defining pre-state and post-state for threat model-based attack techniques may be related to the above-described steps of configuring the state space, the action space, and the reward function.

In addition, the cyber attack sequence generation step may include an environment generation (or initialization) step, a step of loading a trained cyber attack agent training model for which training has been completed, and a step of generating an attack sequence.

Hereinafter, with respect to the reinforcement learning-based cyber attack simulation based on FIGS. 1, 1) a network cyber attack simulation environment generation step will be described through specific examples.

This step corresponds to a step of generating a network cyber attack simulation environment required for training a cyber attack agent, by using a pre-designed simulated training scenario configuration file as an input. Here, the network cyber attack simulation environment may include a network model, an action space, a state space, and a reward function.

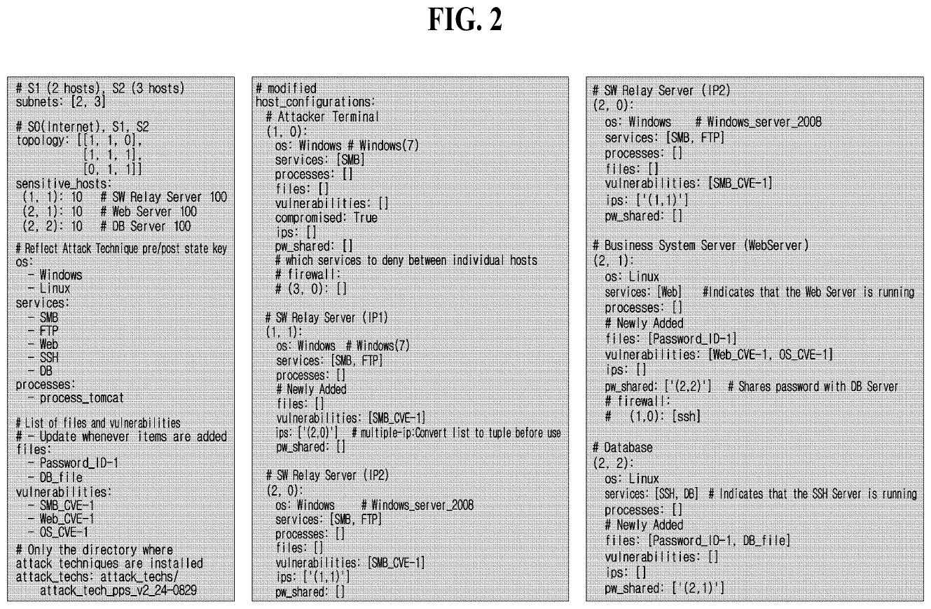

The simulated training scenario configuration file utilized for generating the network cyber attack simulation environment may be configured as illustrated in FIG. 2.

FIG. 2 illustrates a simulated training scenario configuration file according to an embodiment of the present disclosure.

Referring to FIG. 2, the simulated training scenario configuration file may include configuration information for a network (e.g., subnets, topology, firewalls, etc.), configuration information for host assets (e.g., OSs, services, vulnerabilities, files, etc.), and information on attack techniques based on a threat model (e.g., the MITRE ATT&CK framework) in which pre-states/post-states are defined.

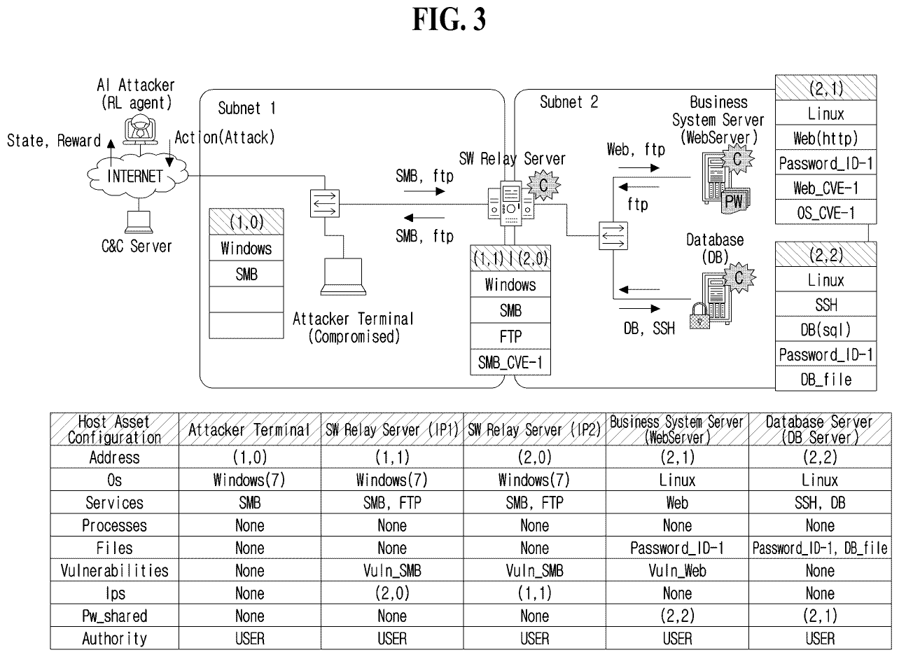

In addition, a network model related to the network cyber attack simulation environment may be configured as illustrated in FIG. 3.

FIG. 3 illustrates a network model according to an embodiment of the present disclosure.

Referring to FIG. 3, the network model may be composed of subnets (subnetworks), topology, hosts, firewalls, and the like.

Specifically, a subnet may index subnets and hosts in a simple subnet address format. For example, (2,0) may represent a first system of subnet 2. All systems within a subnet may communicate with each other, but inter-subnet communication may be controlled by topology and firewall settings.

The topology may define connections between subnets and/or connections to an external network.

A host may be composed of, in addition to an address, an operating system (OS), services, user authority, vulnerabilities, and files executed on the host. Each host may run an OS and one or more services. Each host may have an assigned value, and a higher value may be assigned to a target host of the cyber attack agent. Such a value may be used to calculate a reward due to an action.

A firewall may define matters regarding which communications are allowed or prohibited between subnets.

In addition, an action space related to the network cyber attack simulation environment may be composed of pairs of hosts constituting the network model and attack techniques.

For example, in the proposed method of the present disclosure, the attack techniques may utilize attack sub-techniques provided by the MITRE ATT&CK framework. In the present disclosure, an attack technique may be used with the same meaning as an attack sub-technique

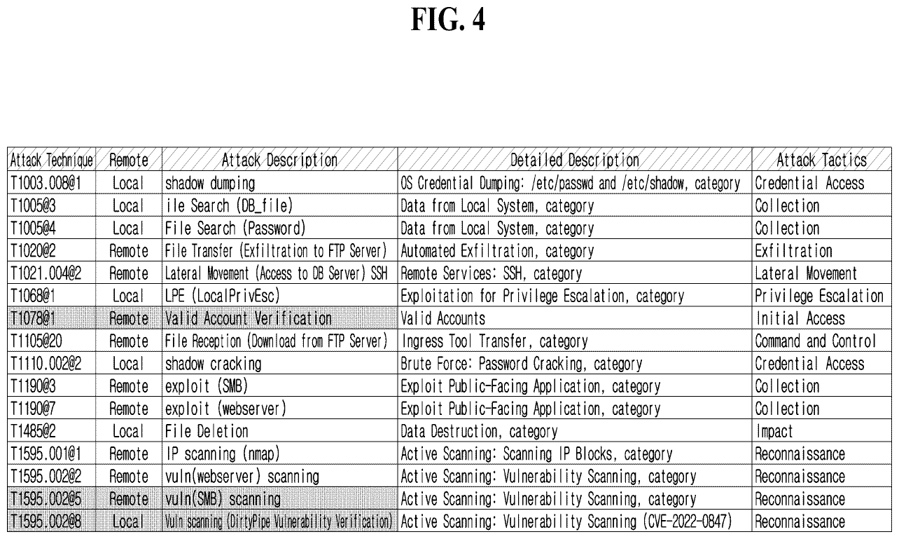

FIG. 4 illustrates attack techniques according to an embodiment of the present disclosure.

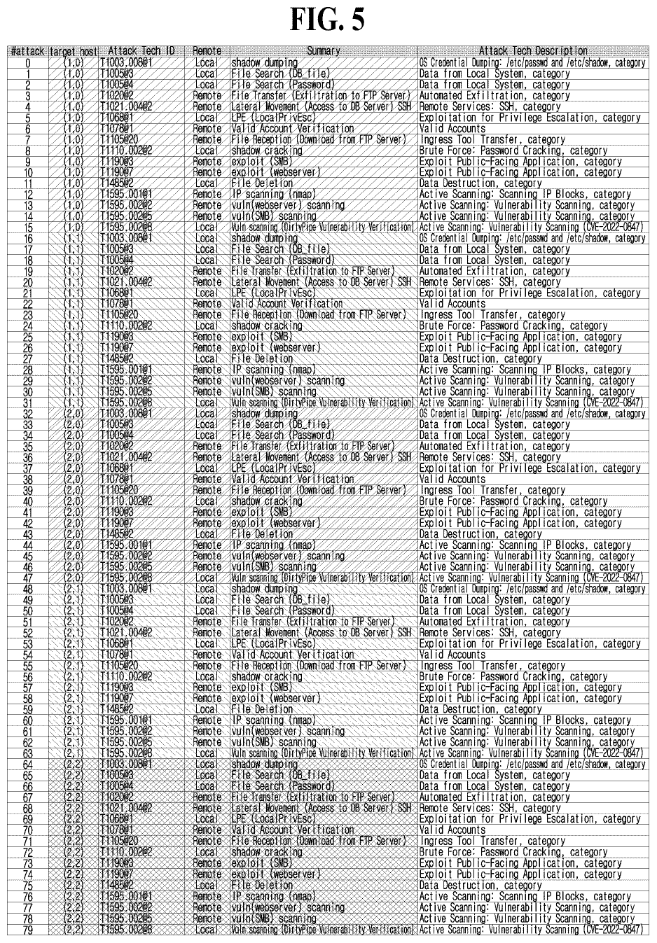

In addition, FIG. 5 illustrates an action space composed of host-specific spatial techniques according to an embodiment of the present disclosure.

With respect to the above-described attack techniques, in order to increase feasibility of an attack scenario when training an attack agent based on reinforcement learning and applying an attack scenario (e.g., an attack sequence) generated by the attack agent to a real-world environment, a method of defining pre-state and post-state features and including the same in the attack techniques may be considered.

Here, a pre-state may refer to a state of a target host required for an attack technique to succeed, and a post-state may refer to a state of the target host that is changed when the attack technique is successfully performed.

Pre-state and post-state (pre-/post-state, PPS) features may be classified into categories such as host status and privilege, and types, states, vulnerabilities, privileges, file access, file identifiers (IDs), etc. of host assets (e.g., OS, service, process, application, file, etc.).

Hereinafter, the above-described PPS features will be described in detail.

Host Status features may include Discovered, Compromised, and Reachable. Each host status may be defined from the perspective of an attack agent (e.g., an RL agent) that generates an attack scenario. Discovered may represent whether the corresponding host is discovered on a network, Compromised may represent whether the corresponding host is taken over, and Reachable may represent whether the corresponding host is reachable. Each value may be represented in a Boolean form (True (1) or False (0)).

Host Privilege features may refer to operation privileges of the corresponding host permitted to the attack agent, and may include User, Admin, and Web. User and Web may indicate user privileges, and Admin may indicate administrator privileges. Each value may be represented in an integer form.

Host assets may include, first, an operating system (OS), services, processes, and applications. Each asset may be classified into type, status, and vulnerability features.

An operating system type (OS_type) may refer to an operating system executed on a host, and may include Linux, Windows, and MacOS. Each value may be represented in an integer form. An operating system status (OS_status) may refer to a state of an operating system executed on a host, and may include Running, Shutdown, and Destroyed. Each value may be represented in an integer form. An operating system vulnerability (OS_vulnerability) may refer to a vulnerability of an operating system executed on a host, and may include CVE-1, . . . , CVE-N. Each value may be represented in an integer form.

A service type (Service_type) may include RDP, VNC, Web, DB, FireWall, AV, Mail, SSH, FTP, log4j, EternalBlue, Tomcat, and SMB. Such items may be additionally defined and expanded as needed. A value of each type may be represented in a Boolean form. A service status (Service_status) may include RDP_s, VNC_s, Web_s, DB_s, FireWall_s, AV_s, Mail_s, SSH_s, FTP_s, log4j_s, EternalBlue_s, Tomcat_s, and SMB_s. Each service status (e.g., RDP_s) may include Running, Stop, Unavailable, and Infected. A value of each status may be represented in an integer form. A service vulnerability (Service_vulnerability) may include RDP_v, VNC_v, Web_v, DB_v, FireWall_v, AV_v, Mail_v, SSH_v, FTP_v, log4j_v, EternalBlue_v, Tomcat_v, and SMB_v. Each service vulnerability may include CVE-1, . . . , CVE-N. Each value may be represented in an integer form.

A process type (Process_type) may include Process and AuthProcess. A value of each type may be represented in a Boolean form. A process status (Process_status) may include Process_s and AuthProcess_s. Each process status may include Running, Stop, and Malicious. A value of each status may be represented in an integer form. A process privilege (Process_privilege) may include Process_p and AuthProcess_p. Each process privilege may include User, Admin, and System. A value of each privilege may be represented in an integer form.

An application type (Application_type) may include MS-Product, HWP, Chrome, and IE. Such items may be additionally defined and expanded as needed. A value of each type may be represented in a Boolean form. An application status (Application_status) may include MS-Product_s, HWP_s, Chrome_s, and IE_s. Each application status may include Running, Stop, Unavailable, and Infected. A value of each status may be represented in an integer form. An application vulnerability (Application_vulnerability) may include MS-Product_v, HWP_v, Chrome_v, and IE_v. Each application vulnerability may include CVE-1, . . . , CVE-N. Each value may be represented in an integer form.

In addition, host assets may include file (File) features. File features may be classified into type, status, access, and identifier (ID) features.

A file type (File_type) may include Password, DB, Document, NetworkInfo, UserInfo, Tool, Log, Exploit, Malware, OSInfo, Persistence, and DefenseEvasion. A value of each type may be represented in a Boolean form.

A file status (File_status) may include Password_s, DB_file_s, Document_s, NetworkInfo_s, UserInfo_s, Tool_s, Log_s, Exploit_s, Malware_s, OSInfo_s, Persistence_s, and DefenseEvasion_s. Each file status may include Init, Created, Deleted, Modified, Discovered, Dumped (Copied), Encrypted, Encoded, Compression, Cracked, Received, and Leaked. A value of each status may be represented in an integer form.

File access (Access) may include Password_a, DB_a, Document_a, NetworkInfo_a, UserInfo_a, Tool_a, Log_a, Exploit_a, Malware_a, OSInfo_a, Persistence_a, and DefenseEvasion_a. Each access may include Read, Write, and Execute. A value of each access may be represented in an integer form.

A file identifier (File_Id) may include Password_i, DB_file_i, Document_i, NetworkInfo_i, UserInfo_i, Tool_i, Log_i, Exploit_i, Malware_i, OSInfo_i, Persistence_i, and DefenseEvasion_i. Each file identifier may include ID1, . . . , ID-N. Each value may be represented in an integer form.

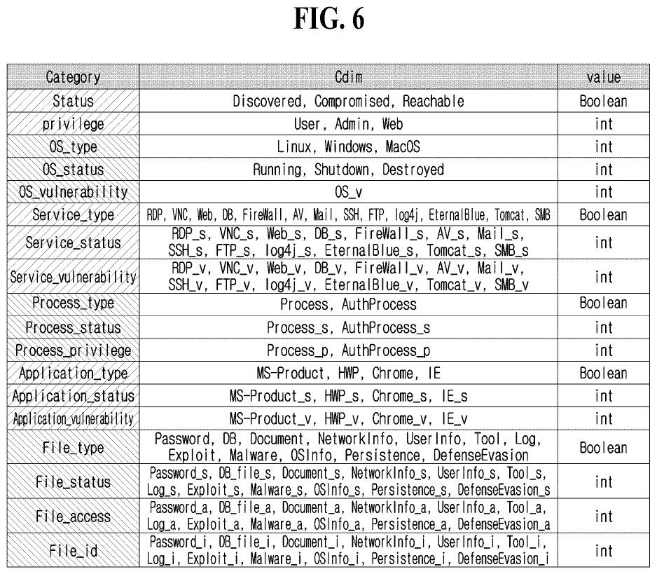

The above-described pre-state and post-state (PPS) features may be represented as illustrated in FIGS. 6 to 8.

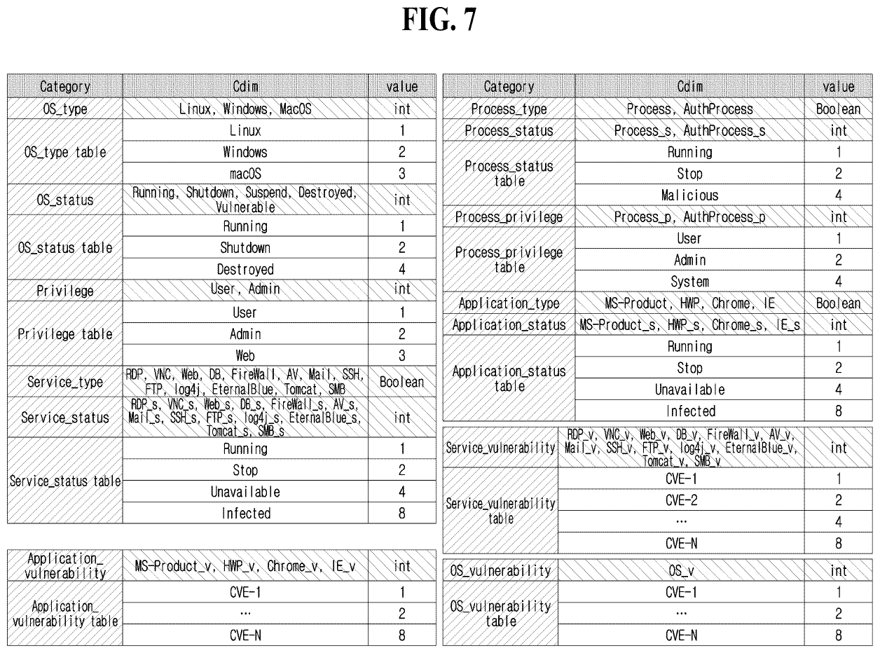

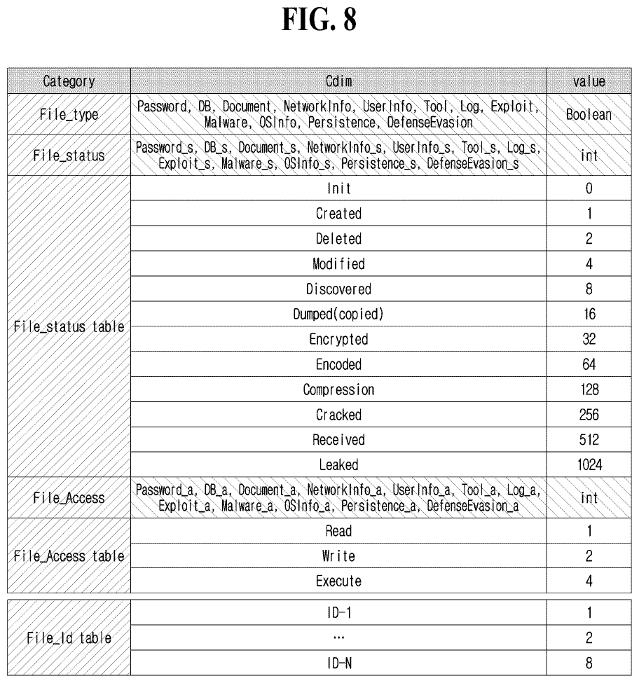

FIG. 6 illustrates types of pre-state and post-state (PPS) features according to an embodiment of the present disclosure. In addition, FIG. 7 illustrates classification of type, state, and vulnerability features for pre-state and post-state (PPS) according to an embodiment of the present disclosure. In addition, FIG. 8 illustrates classification of file features for pre-state and post-state (PPS) according to an embodiment of the present disclosure.

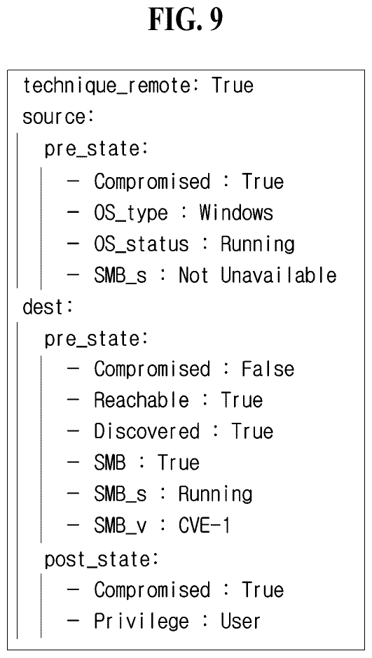

In this regard, pre-state and post-state (PPS) features included in attack techniques according to the proposed method of the present disclosure may be as illustrated in FIG. 9.

FIG. 9 illustrates pre-state and post-state (PPS) defined for attack techniques according to an embodiment of the present disclosure.

Referring to FIG. 9, Technique_remote represents whether an attack technique is a remote (True) or local (False) attack technique. Attack techniques may be classified into a source and a destination according to an entity that performs an attack. In the case of a remote attack technique, a target host of an attack agent (e.g., an RL agent) is a source, and a target host of the attack technique is a destination. In the case of a local attack technique, a target host of the attack agent (e.g., an RL agent) and a target host of the attack technique are the same. In the case of a remote attack technique, pre-state and/or post-state of the source and destination hosts may be defined, and in the case of a local attack technique, pre-state and/or post-state of the destination host may be defined.

A state space may be composed of states of all hosts constituting a network and execution results of attack techniques. A state of each host may be composed of a set of pre-state and post-state (PPS) features defined for all attack techniques. An example of such a feature set may be as follows. [‘privilege’, ‘os_type’, ‘os_status’, ‘os_v’, ‘av’, ‘av_s’, ‘db’, ‘db_s’, ‘eternalblue’, ‘eternalblue_s’, ‘firewall’, ‘firewall_s’, ‘ftp’, ‘ftp_s’, ‘log4j’, ‘log4j_s’, ‘mail’, ‘mail_s’, ‘rdp’, ‘rdp_s’, ‘smb’, ‘smb_s’, ‘smb_v’, ‘ssh’, ‘ssh_s’, ‘tomcat’, ‘tomcat_s’, ‘vnc’, ‘vnc_s’, ‘web’, ‘web_s’, ‘web_v’, ‘db_file’, ‘db_file_a’, ‘db_file_s’, ‘password’, ‘password_a’, ‘password_i’, ‘password_s’]

In addition, the state space may include a host address and a host-assigned value. In addition, the state space may include an observation vector for checking whether an attack technique succeeds.

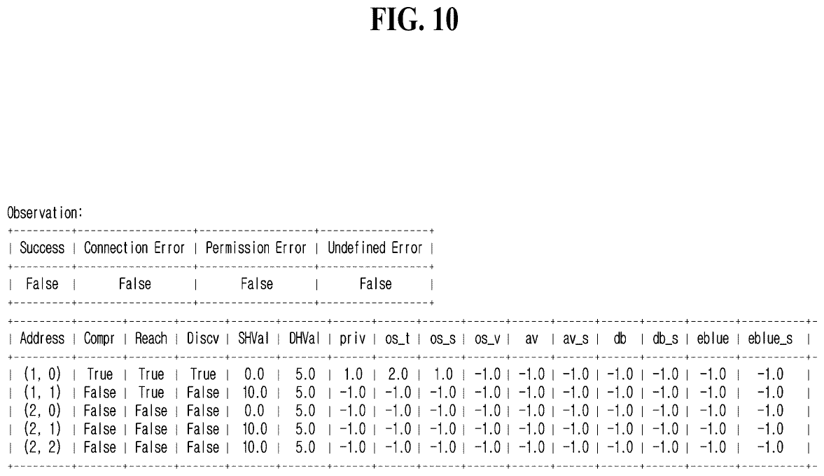

FIG. 10 illustrates a reinforcement learning environment state table configuration using pre-state and post-state of attack techniques according to an embodiment of the present disclosure.

Referring to FIG. 10, the observation vector may include features indicating attack success, and connection/permission/undefined error features.

For example, attack_pps_dict may be as follows. {“Compromised”: “Compr”, “Reachable”: “Reach”, “Discovered”: “Discv”, “Value”: “SHVal”, “Discovery Value”: “DHVal”, “privilege”: “priv”, “os_type”: “os_t”, “os_status”: “os_s”, “eternalblue”: “eblue”, “eternalblue_s”: “eblue_s”, “eternalblue_v”: “eblue_v”, “firewall”: “fw”, “firewall_s”: “fw_s”, “firewall_v”: “fw_v”, “password”: “pw”, “password_s”: “pw_s”, “password_a”: “pw_a”, “password_i”: “pw_i”}

In addition, a reward function may be defined for a transition R(Sₜ₊₁, aₜ, sₜ) as shown in Equation 1.

R(Sₜ₊₁, aₜ, sₜ)=value(Sₜ₊₁, Sₜ)−cost (aₜ) [Equation 1]

In Equation 1, value(Sₜ₊₁, Sₜ) returns a value of a newly compromised host during a transition from st to Sₜ₊₁ when an action (e.g., an attack technique) is performed with cost(aₜ). For example, when a basic cost(aₜ) of a host is −1 and value(Sₜ₊₁, Sₜ) is 0, a reward R(Sₜ₊₁, aₜ, sₜ) for the action is −1.

Next, with respect to the reinforcement learning-based cyber attack simulation based on FIGS. 1, 2) a cyber attack agent modeling (e.g., generation/training) step will be described through a specific example.

In this step, a reinforcement learning-based cyber attack agent is trained to determine an optimal attack technique (e.g., an action) by using environment state information as an input, with respect to a network cyber attack simulation environment generated based on a cyber attack simulated training scenario (e.g., yaml). When training is completed, it may be verified (evaluation) whether a cyber attack scenario (e.g., a cyber attack sequence/vector) for achieving an objective of the training scenario is generated. After verification is completed, the cyber attack agent model may be stored.

At this time, the cyber attack agent may be trained using a reinforcement learning algorithm/technique. Reinforcement learning is composed of an agent and an environment, and the agent may determine an action according to a state of the environment, may apply the determined action to the environment to update the state of the environment, and may receive a corresponding appropriate reward. The same process is repeatedly performed until a learning objective of the agent is achieved.

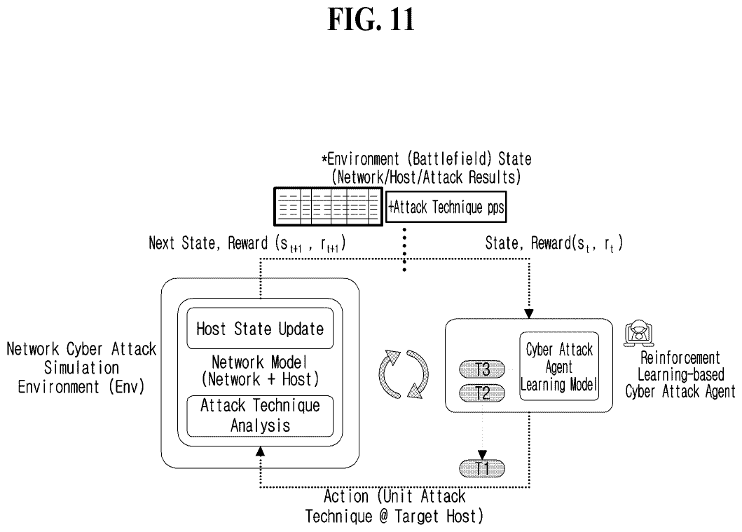

FIG. 11 illustrates a reinforcement learning-based cyber attack agent training model according to an embodiment of the present disclosure.

In this regard, during training of the cyber attack agent, steps and episodes may be defined. One step may be composed of a process in which the agent determines an action according to a state of the environment, applies the determined action to the environment to update the state of the environment, and receives a corresponding appropriate reward. One episode may start from an initial state of the environment and repeatedly perform steps until an objective defined in a simulated training scenario is achieved. When the objective is achieved, the episode is terminated. In addition, when the objective is not achieved up to a predetermined step limit (e.g., step_limit), the episode is terminated.

As an example embodiment of cyber attack agent modeling, a simulated training scenario for reinforcement learning-based cyber attack agent training is designed.

A network cyber attack simulation environment is generated based on a simulated training scenario. Thereafter, a reinforcement learning-based cyber attack agent is trained to determine an optimal action (a target host and an attack technique) by using environment state information as an input with respect to the network cyber attack simulation environment. Training of the cyber attack agent is performed by repeatedly executing episodes until it is determined that model training enabling determination of an optimal action according to an environment state has been completed. After training of the cyber attack agent is completed, a generated attack sequence is compared with and verified against a manual-based attack sequence. Here, the manual-based attack sequence is generated by a manual (user)-based attack agent in the same environment before training of the reinforcement learning-based cyber attack agent, for verification of training results of the reinforcement learning-based cyber attack agent. After verification is completed, the cyber attack agent model is stored. Reinforcement learning algorithms used for the cyber attack agent training model may include Q-Learning, Deep Q-Learning, A2C, PPO, and the like.

In this regard, analysis of attack techniques, and updates of host states and observations may be performed as follows.

When an action of a cyber attack agent is input, the network cyber attack simulation environment may analyze a target host and an attack technique. Thereafter, when the attack technique is applied to the target host, if a state of the host satisfies a pre-state condition of the attack technique, the host state may be updated to a post-state value defined in the attack technique. In addition, when the state of the target host satisfies the pre-state of the attack technique, it may be determined that the attack technique has succeeded. Based on this, an attack success feature of an observation vector may be set to true, and otherwise, the attack success feature may be set to false, and a related one of failure error features (connection/permission/undefined) may be set to true.

For example, a simulated training scenario targets the network cyber attack simulation environment of the above-described network model example, and has an objective of discovering hosts and services in a network by using thirteen (13) types of MITRE ATT&CK attack techniques in which pre-state and post-state features are defined, and of compromising three (3) target hosts (e.g., a SW relay server, a business system server, and a DB server) by using vulnerabilities of corresponding host services.

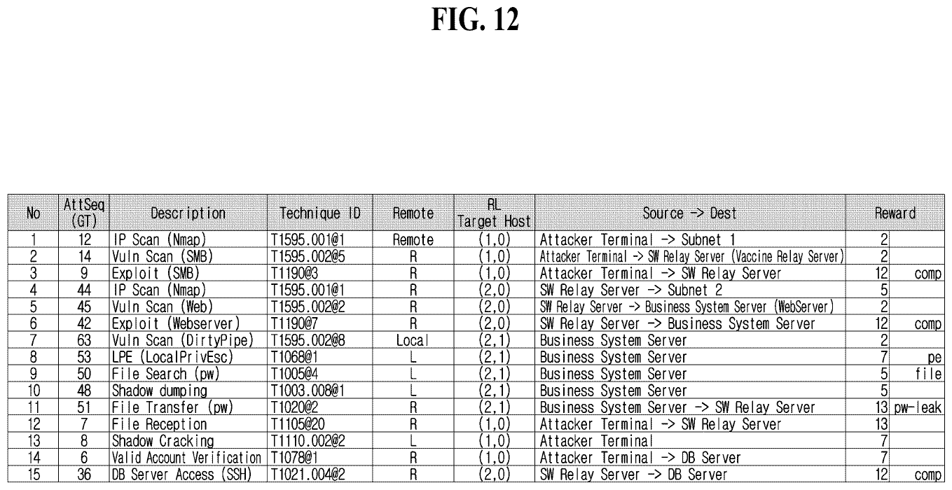

FIG. 12 illustrates an attack sequence provided in a simulated training scenario according to an embodiment of the present disclosure.

In the case of a manual-based attack sequence, a user directly selects an attack technique by checking an environment state table and an attack technique (e.g., action) list, and an attack sequence may be generated based thereon.

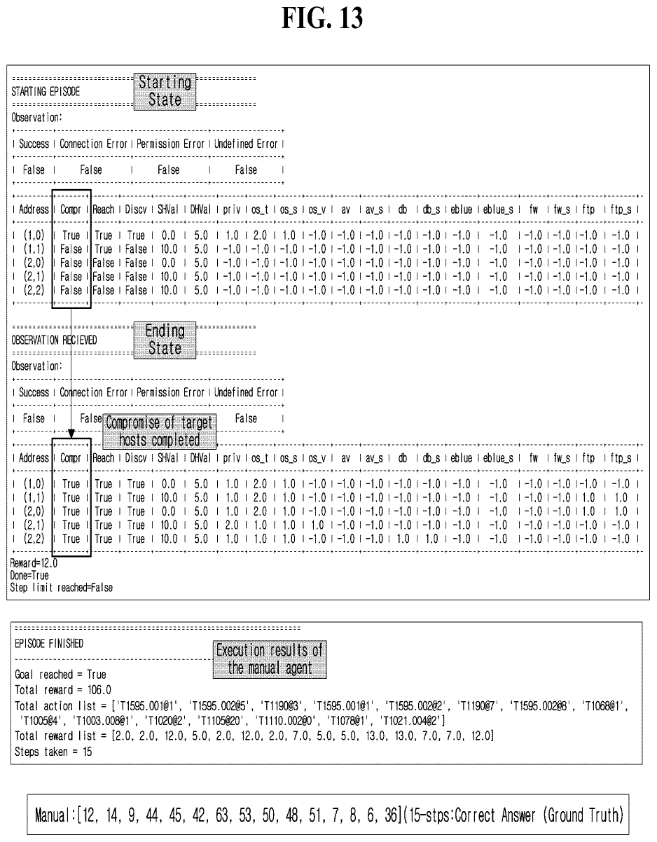

FIG. 13 illustrates a manual-based attack sequence according to an embodiment of the present disclosure.

In FIG. 13, an attack sequence number (e.g., [12, 14, 9, 44, 45, 42, 63, 53, 50, 48, 51, 7, 8, 6, 36]) may indicate an index number of an action space in the example of an action space composed of host-specific spatial techniques in FIG. 5.

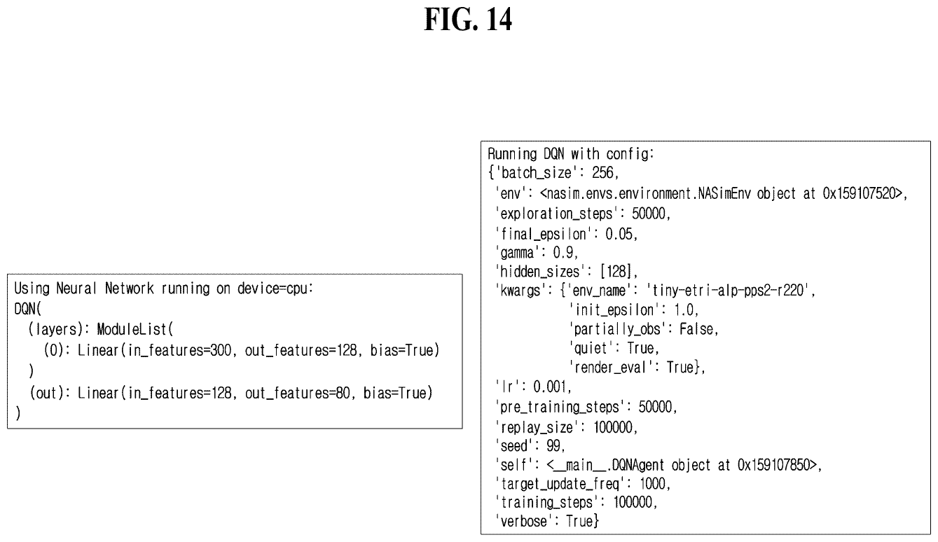

In this regard, a reinforcement learning (for example, Deep Q-Learning)-based cyber attack agent may be trained. As one embodiment, a reinforcement learning algorithm may use a DQN (Deep Q-Network). A DQN network structure and hyper-parameter settings for training may be as illustrated in FIG. 14.

FIG. 14 illustrates a DQN network structure and training hyper-parameters according to an embodiment of the present disclosure.

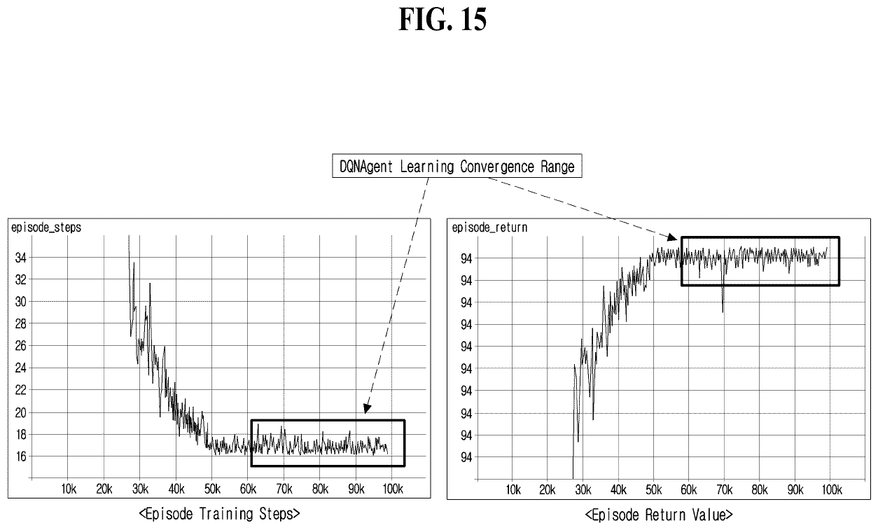

Training results of a cyber attack agent trained based on the above-described attack sequences, DQN network structure, and training hyper-parameters may be as illustrated in FIG. 15.

FIG. 15 illustrates training results of a cyber attack agent according to an embodiment of the present disclosure.

Referring to FIG. 15, a return per episode may converge to approximately 112 when training steps exceed 60k. In addition, the number of training steps per episode may converge to approximately 15 when the training steps exceed 60k.

After training of the cyber attack agent is completed, comparative verification between an attack sequence generated thereby and a manual-based attack sequence may be performed.

For example, as an episode result after DQN convergence, an attack sequence may have seventeen (17) steps (similar to the manual sequence), an episode return may be 112, a goal may be achieved (three (3) hosts are compromised), and training steps may be 100,000.

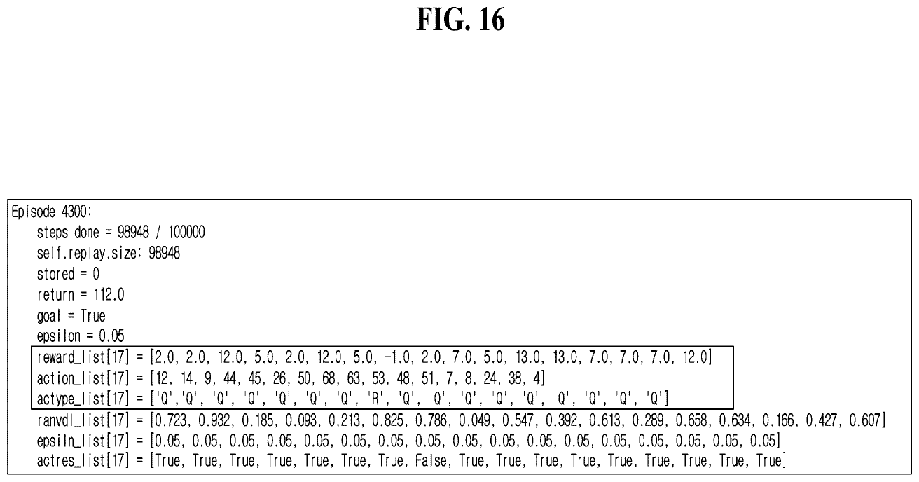

An attack scenario generated by a DQL agent at a timing of training completion may be as illustrated in FIG. 16.

FIG. 16 illustrates an attack scenario generated by a DQL agent at a timing of training completion according to an embodiment of the present disclosure.

After the above-described verification is completed, a cyber attack agent training model (e.g., a structure and parameters) may be stored.

Next, with respect to the reinforcement learning-based cyber attack simulation based on FIGS. 1, 3) a cyber attack sequence (e.g., a cyber attack scenario) generation step will be described through a specific example.

In this step, a previously trained cyber attack agent training model may be loaded, and an operation of generating an attack sequence composed of attack techniques for achieving an objective of a simulated training scenario may be performed with respect to a network cyber attack simulation environment of the simulated training scenario

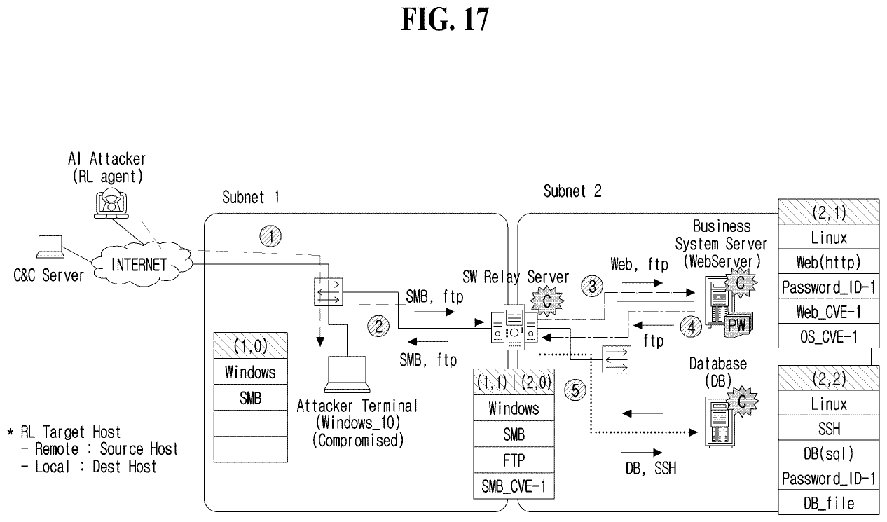

FIG. 17 illustrates a simulated training scenario configuration and an attack execution procedure according to an embodiment of the present disclosure.

As an example embodiment of cyber attack sequence generation, after loading a previously trained cyber attack agent training model, a cyber attack agent may automatically generate an attack sequence composed of attack techniques based on a modified threat model (e.g., the MITRE ATT&CK framework) with respect to an initialized network cyber attack simulation environment.

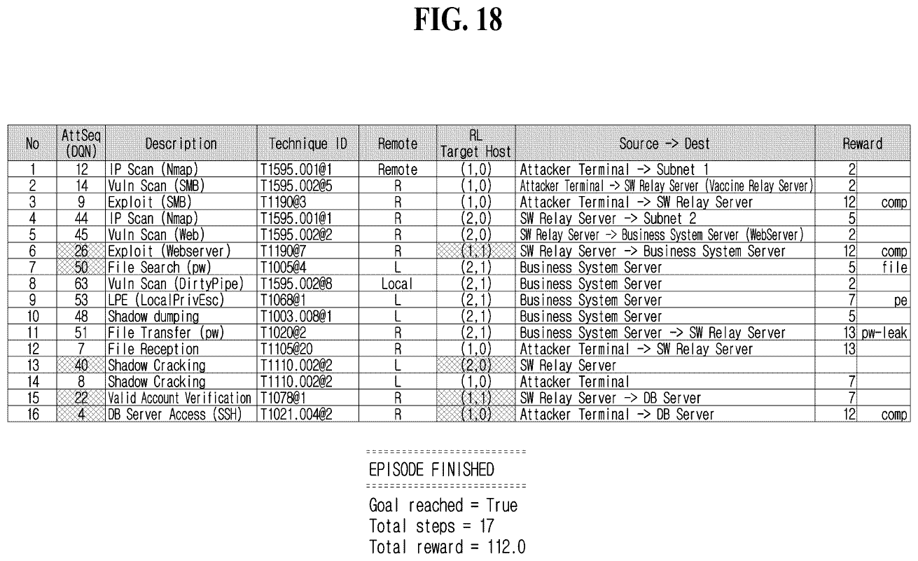

FIG. 18 illustrates an attack sequence composed of attack techniques based on a modified threat model according to an embodiment of the present disclosure.

Referring to FIG. 18, the trained cyber attack agent may automatically generate/modify attack techniques based on a threat model (e.g., the MITRE ATT&CK framework). An attack sequence may be generated based on the generated/modified attack techniques.

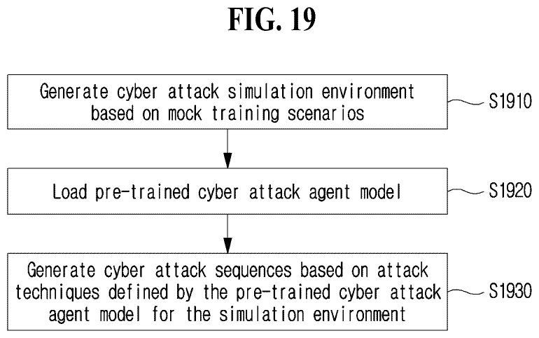

FIG. 19 illustrates an operational flowchart of a cyber attack sequence generation method according to an embodiment of the present disclosure.

Operations described in FIG. 19 may be based on the methods/operations described in the present disclosure with reference to FIGS. 1 to 18.

In step S1910, a cyber attack simulation environment may be generated based on a simulated training scenario.

For example, the cyber attack simulation environment may include a network model, an action space, a state space, and a reward function. Here, the action space may be composed of information on pairs of target hosts included in the network model and attack techniques, and the state space may be composed of information on states of all hosts included in the network model and execution results of attack techniques.

In step S1920, a pre-trained cyber attack agent model may be loaded.

For example, the pre-trained cyber attack agent model may be stored based on i) iterative learning for determining an optimal action based on input environment state information and ii) comparative verification with a manual-based attack sequence.

In step S1930, the cyber attack sequence may be generated based on attack techniques defined by the pre-trained cyber attack agent model with respect to the cyber attack simulation environment.

For example, the attack techniques may be based on attack sub-techniques of a threat model (e.g., the MITRE ATT&CK framework).

In addition, according to the present disclosure, the attack techniques may be defined based on analysis of attack techniques provided in the simulated training scenario and updates of host states.

In addition, according to the present disclosure, when the attack technique corresponds to a remote attack technique, the at least one host may include a source host and a destination host. In contrast, when the attack technique corresponds to a local attack technique, the at least one host may include a destination host.

In addition, according to the present disclosure, features for pre-states and post-states may include at least one of host status features, host privilege features, or host asset features, and the host asset features may include one or more of operating system-related features, service-related features, application-related features, or file-related features. In this regard, each of the operating system-related features, the service-related features, and the application-related features may be classified into one or more of type features, status features, or vulnerability features. In addition, the file-related features may be classified into one or more of type features, status features, access permission features, or identifier features.

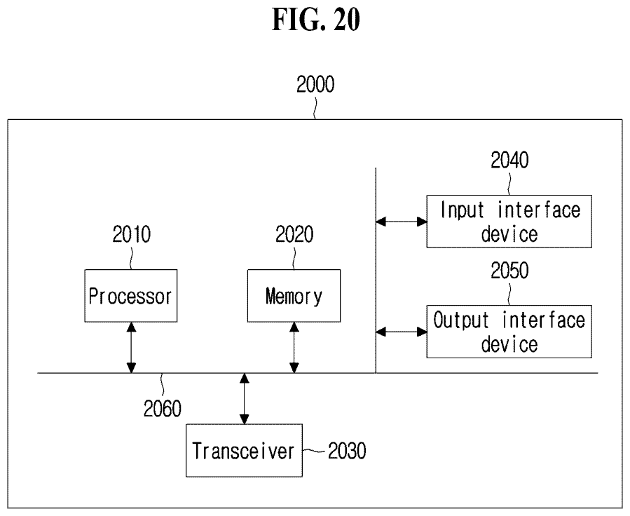

FIG. 20 is a block diagram illustrating a device according to an embodiment of the present disclosure.

Referring to FIG. 20, a device (2000) may represent a device in which a method of defining pre-state and post-state features for threat model-based attack techniques described in the present disclosure and generating an attack sequence based thereon is implemented.

The device (2000) may include at least one of a processor (2010), a memory (2020), a transceiver (2030), an input interface device (2040), and an output interface device (2050). The respective components may be connected to each other via a common bus (2060) to perform communication. In addition, the respective components may be connected not via the common bus (2060) but via individual interfaces or individual buses centered on the processor (2010).

The processor (2010) may be implemented as various types such as an AP (Application Processor), a CPU (Central Processing Unit), a GPU (Graphic Processing Unit), and the like, and may be any semiconductor device that executes instructions stored in the memory (2020). The processor (2010) may execute program commands stored in the memory (2020). The processor (2010) may be configured to implement the method of defining pre-state and post-state features for threat model-based attack techniques and generating an attack sequence based thereon, which has been described above with reference to FIGS. 1 to 19.

And/or, the processor (2010) may store program commands for implementing at least one function for the corresponding modules in the memory (2020), and may control execution such that operations described with reference to FIGS. 1 to 19 are performed.

The memory (2020) may include various types of volatile or non-volatile storage media. For example, the memory (2020) may include a ROM (read-only memory) and a RAM (random access memory). In an embodiment of the present disclosure, the memory (2020) may be located inside or outside the processor (2010), and the memory (2020) may be connected to the processor (2010) through various known means.

The transceiver (2030) may perform a function of transmitting and receiving data processed/to be processed by the processor (2010) to and from an external device and/or an external system.

The input interface device (2040) may be configured to provide data to the processor (2010).

The output interface device (2050) may be configured to output data from the processor (2010).

According to an embodiment of the present invention, by utilizing artificial intelligence (AI)-based cyber attack-and-defense simulation technology, vulnerability analysis and evaluation of cyber response strategies for national critical infrastructures (e.g., energy, transportation, manufacturing, etc.) may be performed, thereby being applicable to securing cyber safety of national critical infrastructures, which provides a technical effect of preventing large-scale economic and social damages that may occur upon occurrence of a cyber attack.

In addition, according to an embodiment of the present invention, the AI-based cyber attack-and-defense simulation technology has a technical effect of being usable as a cyber attack/defense training platform for cultivating cyber security personnel in order to enhance cyber warfare response capabilities. In this regard, by generating/providing training-purpose-customized cyber attack-and-defense scenarios using artificial intelligence technology, there is an advantage that highly trained cyber security personnel may be cultivated.

In addition, according to an embodiment of the present invention, by utilizing AI-based cyber attack and defense scenarios, there is an advantage in that the scenarios may be used as a security consulting tool for ICT infrastructures of private and public institutions and as a function/performance evaluation/verification tool for security solutions installed in a target domain.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method for generating a cyber attack sequence, comprising:
generating a cyber attack simulation environment based on a simulated training scenario;
loading a pre-trained cyber attack agent model; and
generating the cyber attack sequence based on attack techniques defined by the pre-trained cyber attack agent model for the cyber attack simulation environment,
wherein the attack techniques include features for a pre-state and a post-state for at least one host.

2. The method of claim 1,
wherein, based on the attack technique corresponding to a remote attack technique, the at least one host includes a source host and a destination host, and
based on the attack technique corresponding to a local attack technique, the at least one host includes a destination host.

3. The method of claim 1,
wherein the features for the pre-state and the post-state include at least one of a host status feature, a host privilege feature, or a host asset feature, and
the host asset feature includes one or more of an operating system-related feature, a service-related feature, an application-related feature, or a file-related feature.

4. The method of claim 3,
wherein each of the operating system-related feature, the service-related feature, and the application-related feature is classified into one or more of a type feature, a status feature, or a vulnerability feature.

5. The method of claim 3,
wherein the file-related features are classified into one or more of a type feature, a status feature, an access permission feature, or an identifier feature.

6. The method of claim 1,
wherein the pre-trained cyber attack agent model is stored based on i) iterative learning for determining an optimal action based on input environment state information and ii) comparative verification with a manual-based attack sequence.

7. The method of claim 1,
wherein the attack techniques are defined based on analysis of attack techniques provided in the simulated training scenario and updates of host states.

8. The method of claim 1,
wherein the cyber attack simulation environment includes a network model, an action space, a state space, and a reward function,
wherein the action space includes information for pairs of target hosts included in the network model and attack techniques, and
wherein the state space includes information for states of all hosts included in the network model and execution results of attack techniques.

9. The method of claim 1,
wherein the attack techniques are based on attack sub-techniques of a threat model.

10. An apparatus for generating a cyber attack sequence, the apparatus comprising:
one or more processors and one or more memories,
wherein the one or more processors are configured to:
generate a cyber attack simulation environment based on a simulated training scenario;
load a pre-trained cyber attack agent model; and
generate the cyber attack sequence based on attack techniques defined by the pre-trained cyber attack agent model for the cyber attack simulation environment,
wherein the attack techniques include features for a pre-state and a post-state for at least one host.

11. The apparatus of claim 10,
wherein, based on the attack technique corresponding to a remote attack technique, the at least one host includes a source host and a destination host, and
based on the attack technique corresponding to a local attack technique, the at least one host includes a destination host.

12. The apparatus of claim 10,
wherein the features for the pre-state and the post-state include at least one of a host status feature, a host privilege feature, or a host asset feature, and
the host asset feature includes one or more of an operating system-related feature, a service-related feature, an application-related feature, or a file-related feature.

13. The apparatus of claim 12,
wherein each of the operating system-related feature, the service-related feature, and the application-related feature is classified into one or more of a type feature, a status feature, or a vulnerability feature.

14. The apparatus of claim 12,
wherein the file-related features are classified into one or more of a type feature, a status feature, an access permission feature, or an identifier feature.

15. The apparatus of claim 10,
wherein the pre-trained cyber attack agent model is stored based on i) iterative learning for determining an optimal action based on input environment state information and ii) comparative verification with a manual-based attack sequence.

16. The apparatus of claim 10,
wherein the attack techniques are defined based on analysis of attack techniques provided in the simulated training scenario and updates of host states.

17. The apparatus of claim 10,
wherein the cyber attack simulation environment includes a network model, an action space, a state space, and a reward function,
wherein the action space includes information for pairs of target hosts included in the network model and attack techniques, and
wherein the state space includes information for states of all hosts included in the network model and execution results of attack techniques.

18. The apparatus of claim 10,
wherein the attack techniques are based on attack sub-techniques of a threat model.

19. One or more non-transitory computer-readable media storing one or more instructions,
wherein the one or more instructions are executed by one or more processors such that an apparatus for generating a voxel-wise texture patch controls to:
generate a cyber attack simulation environment based on a simulated training scenario;
load a pre-trained cyber attack agent model; and
generate the cyber attack sequence based on attack techniques defined by the pre-trained cyber attack agent model for the cyber attack simulation environment,
wherein the attack techniques include features for a pre-state and a post-state for at least one host.
